(19) United States
(12) Patent Application Publication
(10) Pub. No.: US 2023/0235868 A1
(43) Pub. Date: Jul. 27, 2023

(54) High Efficiency Daylighting Devices

(71) Applicant: SerraLux Inc., Los Gatos, CA (US)

(72) Inventor: MARK E GARDINER, SANTA ROSA, CA (US)

(21) Appl. No.: 18/160,968

(22) Filed: Jan. 27, 2023

Related U.S. Application Data
(60) Provisional application No. 63/303,774, filed on Jan. 27, 2022.

(51) Int. Cl. F21S 11/00; G02B 19/00; F21V 7/04

(52) U.S. Cl. CPC F21S 11/007; F21V 7/04; G02B 19/0019; G02B 19/0042

(57) ABSTRACT

An optical panel deploys stacks of spaced apart louvers with reflective surface for redirecting exterior sunlight to day light the interior of room ceiling distal from windows. The reflective surfaces my be shaped with modulations in shape to enhance the spreading of reflected light under various lighting conditions that occur as the sun moves through the sky during the day.

### CROSS REFERENCE TO RELATED APPLICATIONS

The present application claims the benefit of priority to the U.S. Provisional Pat. Application with the same title having Application Serial No. 63/303,774, which was filed on Jan. 27, 2022, and is incorporated herein by reference.

### BACKGROUND OF INVENTION

The field of invention is building construction, and more specifically optical assemblies for beneficially re-directing light that enters the buildings via glazing.

It has long been recognized that various optical components placed on or behind glazing structures can redirect incident light upward toward the ceiling 12s, where it can scatter and penetrate father into the interior of the structure, which is more distal from ordinary glazing.

Transmissive daylight structures are well known in the prior art, but few have been commercialized, and those are not in widespread use, despite the potential in energy savings and beneficial effects of natural light on inhabitants.

In addition to the expense to make and install diverse types of transmissive and reflective daylight device on or adjacent glazing, there are potential negative attributes under some lighting conditions during the day, as well as limitations on performance efficiency during the day.

On such negative attribute is columnar glass. Another is blocking or obstructing a clear view outside through the windows.

While properly spaced reflective louvers offer some daylighting benefits, they generally create a related from of distractive glare in projecting very bright images discrete louvers on the ceiling 12 and have limited effectiveness at some sun elevations and azimuthal angle relate to the normal direction of the glazing.

This invention primarily pertains to reflective daylight surfaces, especially reflective, horizontal louvers. Prior art louvers have incorporated mirrored surfaces on the top or bottom surface of a plano louver.

This results in discrete reflections from each individual louver that show up on the internal ceiling 12 of the room where the daylighting is being re-directed. These reflections are extremely bright because of the collimated nature of the sun. The reflections are annoying to occupants in the room because they are so bright that they can be considered as glare. Further, they cause bright reflections from the screens of modem electronic devices like computers, tablets, and cell phones. Further, as louvers are never precisely uniform in shape or spacing based on spatial variations in forming operation of attachment to the hanging and/or titling mechanism, the bright lines vary in shape and spacing, forming rather irregular patterns of the interior ceiling 12.

It would be advantageous to provide a means to capture external light and re-direct it in a manner that avoids glare or other forms of excess brightness, as well as solar heating effects that is also dynamically responsive to the changing solar elevation angle throughout the day.

It would be advantageous to provide a means to capture external light and re-direct it in a manner that is highly efficient to also create a more pleasant work environment by projecting the light in a greater depth and range to the actual workspaces, and avoid distracting patterns of light on the interior ceiling 12

The above and other objects, effects, features, and advantages of the present invention will become more apparent from the following description of the embodiments thereof taken in conjunction with the accompanying drawings

### SUMMARY OF INVENTION

In the present innovation, the first object is achieved by providing an optical panel that comprises a plurality spaced apart elongated reflective elements arranged in a stack that spans a height of the optical panel and each reflective element in said plurality has a first surface and an opposing second surface in which at least one reflective layer is one of disposed on the first surface, the second surface and between the first and second surface, the at least one of the upper surface and the reflective layer being further characterized by a continuous modulation in depth in a direction orthogonal to a principal axis of the elongated reflective elements.

A second aspect of the innovation is characterized by such an optical panel in which the continuous modulation in depth is further characterized by vary periodically in circular arcs that oscillate between an upper arc portion of a circle and a lower arc portion of the circle in which a maximum tangent angle to the shape of the continuous modulations in depth occurs at junctions between the upper arc portions with the lower arc portion.

Another aspect of the innovation is characterized by any such optical panel which the continuous modulations in depth have the maximum tangent angle that is less than about 5 degrees.

Another aspect of the innovation is characterized by any such optical panel in which the continuous modulation in depth is further characterized by a maximum tangent angle to the shape of the continuous modulations in depth that is at least about 1 degree.

Another aspect of the innovation is characterized by any such optical panel in which the continuous modulations occur within a plurality of adjacent bands spaced apart along the principal axis of the elongated reflective elements in which each band extends in a direction orthogonal to the principal axis of the elongated elements.

Another aspect of the innovation is characterized by any such optical panel in which the continuous modulations occur within a plurality of adjacent bands spaced apart along the principal axis of the elongated reflective elements in which each band extends in a direction orthogonal to the principal axis of the elongated elements.

Another aspect of the innovation is characterized by any such optical panel in which at least some of bands in the plurality vary in one of depth and phase from at least one of the nearest neighboring bands.

### BRIEF DESCRIPTION OF DRAWINGS

FIG. 1A is a schematic side elevation view of an optical panel formed from a plurality of stacked louvers whereas FIG. 1B is a schematic top plan view of a single representative louver that are stacked in a vertically spaced arrangement to form the optical panel.

FIGS. 2A, B and C are respectively schematic section, perspective and plan views of a first embodiment of the innovation showing portions of a louver. The H or horizontal axis scale is greatly exaggerated, that is enlarged relative to the T or transverse axis scale to better illustrate modulations in surface shape of the reflective portion of the louvers.

FIGS. 3A-C are schematic section views through alternative embodiments of the louver to indicate alternative positions of the reflective layer within the louver as well as other layers in various potential laminated constructions.

FIGS. 4A-B are respectively schematic ray tracing diagrams to how indicate how incident sunlight is reflected toward the ceiling in conventional reflective louvers (FIG. 4A) compared with improvements from various embodiments of the innovation (FIG. 4B).

FIG. 5 is a cross-section elevation view of a more preferred effective shape of the reflective portion of the louver.

FIG. 6 is a perspective view of a tool optionally used to form components of the louvers.

FIGS. 7A-B are schematic cross-sectional elevation views of another embodiment of a louver or reflective component thereof taken respectively at section lines A-A and B-B in FIG. 7C, which is a plan view of a portion of the louver.

FIGS. 8A-B are schematic cross-sectional elevation views of another embodiment of a louver or reflective component thereof taken respectively at section lines A-A and B-B in FIG. 8C, which is a plan view of a portion of the louver.

FIGS. 9A-B are schematic orthogonal cross-sectional elevation views of another embodiment of a louver or reflective component thereof taken respectively at section lines A-A and B-B in FIG. 9C, which is a plan view of a portion of the louver.

FIGS. 10A-B are schematic orthogonal cross-sectional elevation views of another embodiment of a louver or reflective component thereof taken respectively section lines A-A and B-B in FIG. 10C, which is a plan view of a portion of the louver.

FIGS. 11 is a schematic cross-section view of another embodiment of the louver, which included the reflective surface deposited on the bands or grooves 113, in which the bands 113A and 113B are shown as having a different depth, which at the same cross-section can be due to a phase offset of the surface shape along the band, orthogonal to the principal axis, P, of the louver 110. The regions between the bands 113A and 113B is sloped as a result of the draft angle of the diamond tool used to cut the master.

FIGS. 12A and 12B schematically illustrate respectively the variation in light patterns on the interior ceiling (right side of each FIG.) when the incident light arrives at zero azimuthal angle, near the solar zenith (FIG. 10A) versus a high azimuthal angle δ closer to sunrise or sunset for north and south facing windows corresponding to the alternative embodiments of FIGS. 7A-11. The left side of FIGS. 12A and 12B are plan views of a representative louver to indicate the reflection of light incident.

FIGS. 13A-C are schematic side elevation view rays tracing to show the effect incident light that arrives at zero azimuthal angle, near the solar zenith, but at variation from the optimum angle of incidence β, for a particular louver aspect ratio of louver spacing to width in the transverse direction.

FIGS. 14A-C are schematic side elevation views of an optical panel formed from a plurality of stacked louvers showing the collective tilting of the louvers at different orientations.

FIG. 15A and FIG. 15B are cross-section elevation views of an optical panel formed from a plurality of stacked louvers deployed between layers of window glazing.

### DETAILED DESCRIPTION

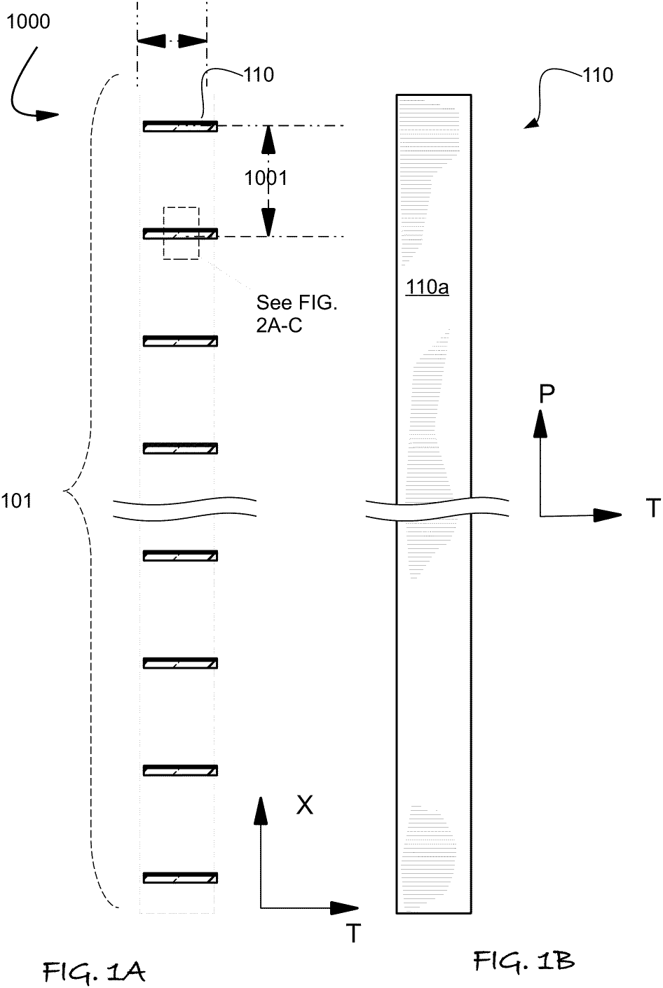

Referring to FIGS. 1A through 15B, wherein like reference numerals refer to like components in the various views, there is illustrated therein a new and improved High Efficiency Daylighting Devices, generally denominated 1000 herein.

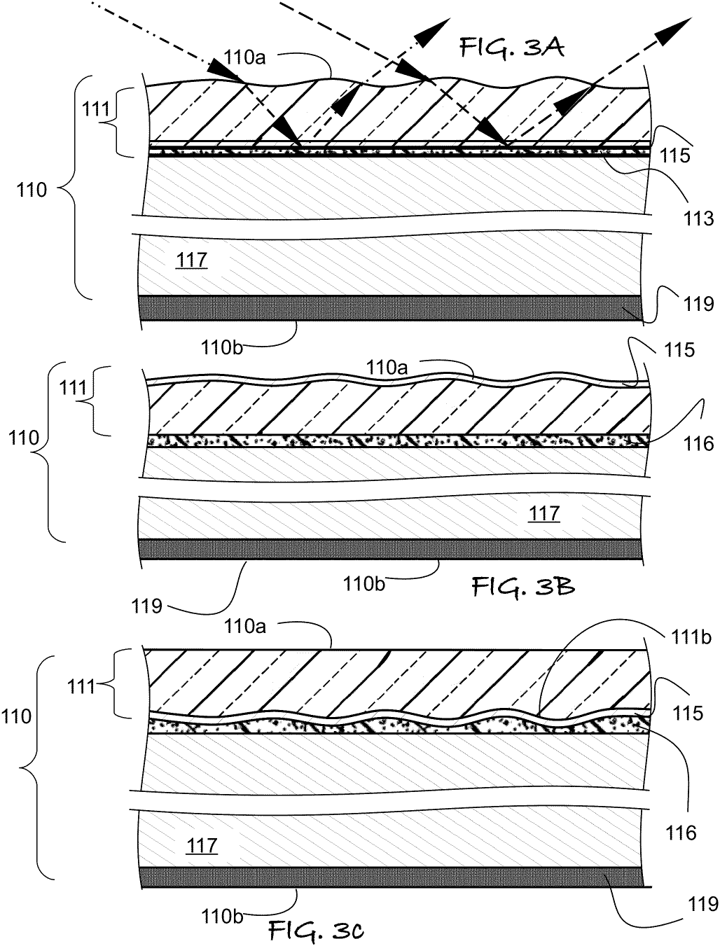

As illustrated in FIGS. 3A-B, the high efficiency daylighting devices 1000 of the current innovation deploy a plurality of reflective surfaces 115 that extend horizontally and are stacked in a vertical array of louvers 110 for placement adjacent glazing or in opening in structure to re-direct incident light. Daylighting devices re-direct sunlight incident through windows or glazing upward toward the room ceiling 12, where it can diffused by scattering to penetrate further into the room as rays 13. But for the reflections from the daylighting devices the sun light as rays 10 would otherwise impinge on the floor or in the early morning and near dusk be nearly parallel to the floor and cause oppressive glare to inhabitants of the room when it impinges directly on their eyes.

It should be appreciated that in any of the above embodiments the louvers 110 and daylighting devices 1000 can be formed of or on glass, ceramic, metallic or polymeric substrates and may constructed of laminates of any combination of layers of glass, ceramic, metallic and polymer. Such polymeric layers are attractive for continuous coating of metal and dielectric mirrors by roll-roll vacuum coating processes, as the cost is much less than glass and the weight is reduced. Such lamination may be macroscopic with visible layers for improve the stiffness to weight of the components of the daylighting devices 1000, or microscopic in which thin film layers modulate the transmission and reflection of light by an combination of absorption, including no absorption, constructive and destructive interference of incident light.

An objective of the invention is to provide daylighting constructions with improved efficiency. It is desirable to improve the day lighting efficiency of the louvers 110 by providing configurations that minimize light leakage of incident rays through gaps 10 such that they do not make a single reflection of the louvers 110. It is also desirable to eliminating light lost to vignetting by an upper louver 110, that is after the incident rays of sunlight 10 reflecting off a lower louver 110 as rays 11 to reach the ceiling 12 of the adjacent room impinge on the bottom of the upper louver 110. If a second reflection occurs off the upper louver 110 then the incident rays would be directed downward like leaked light rays toward the floor of the room, rather than the ceiling 12.

In the embodiment of FIGS. 1A-B the high efficiency daylighting device 1000 is an optical panel 101 that comprises a plurality spaced apart elongated reflective elements, which are also referred to as louvers 110 arranged in a stack that spans a height of the optical panel 101 and each louver 110 in said plurality has a first surface 110a and an opposing second surface 110b. There is at least one reflective layer or surface 115 that is one of disposed on the first surface 110a, the second surface 110b and between the first 110a and second 110b surfaces. FIG. 1B is a top plan view of a single louver 110 to define the principal axis P and the transverse axis T.

In the daylighting device 1000 as illustrated in FIG. 1A, there are spaces or air gaps 1001 between the louvers 110 having the reflective layers or surfaces 115. The reflective layer or surface 115 of vertically arrayed louvers 110 may have various support substrates or superstrates to maintain the spaced apart relationship and optionally allow rotation of the reflective surfaces 115 at or nearly about a horizontal axis of each reflective surface 115, such as by titling the supporting substrate or superstrate.

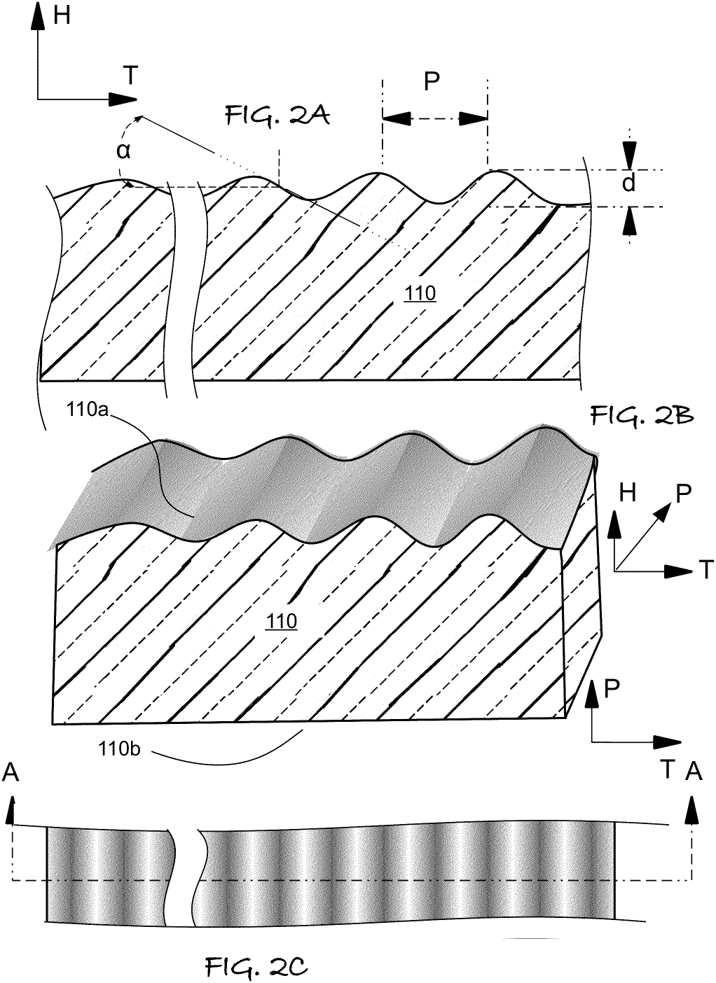

Preferably there is a continuous modulation in depth of the upper surface 110a or the effective reflective surface over a fixed periodic P, such as in the form of a sine wave, with a slope α being defined by a tangent to the mean value or inflection point as illustrated in FIG. 2A, among other Figures. Either the reflective layer 115 or the upper surface of the louver 110a has a continuous modulation in depth, d, in the transverse direction that is orthogonal to the principal axis P of the louver or elongated reflective elements 110.

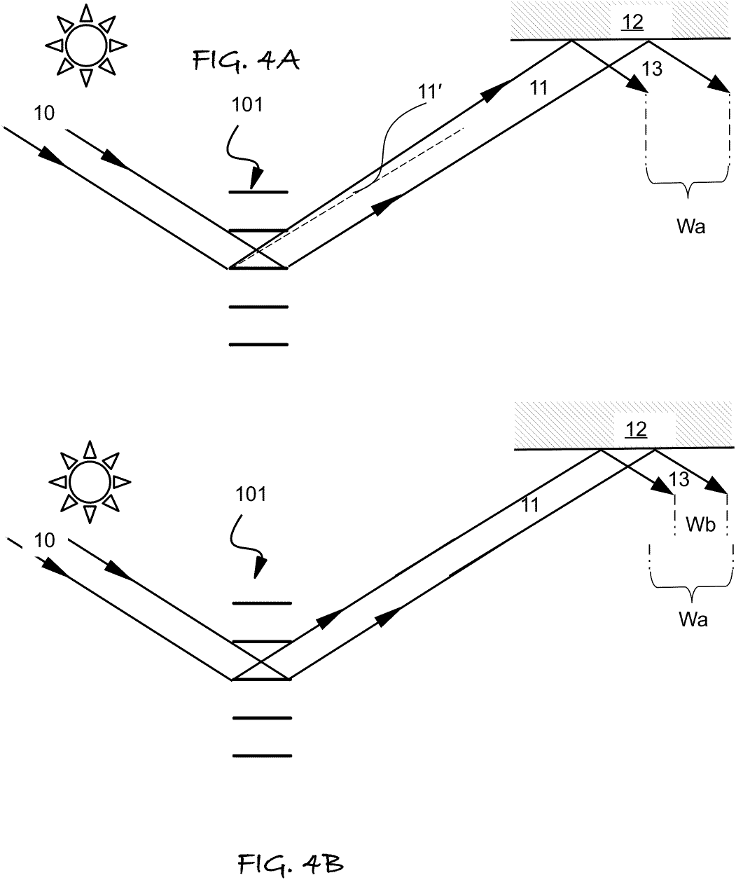

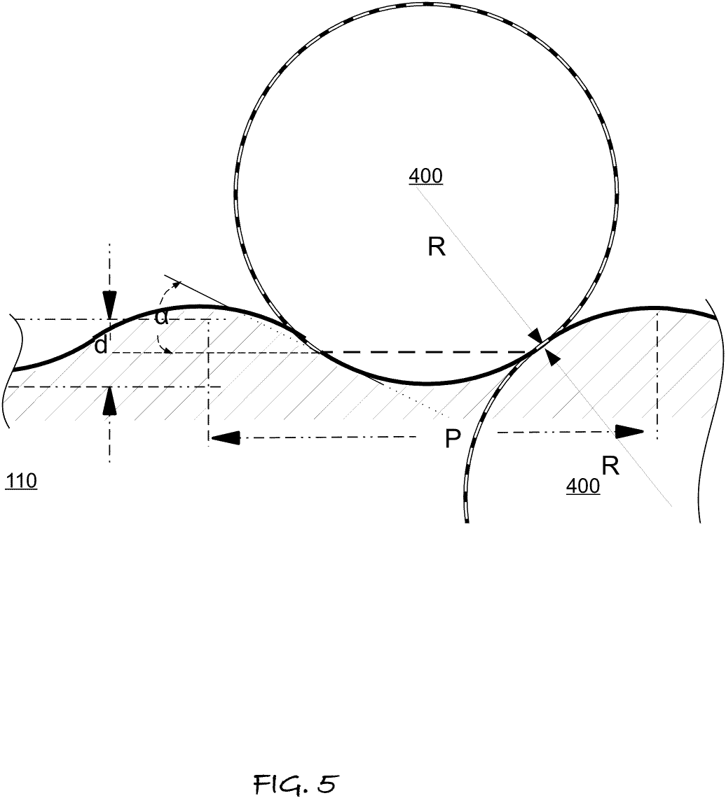

It should be appreciated that FIGS. 5 and 7A-10C illustrate alternative surface shapes of a portion of the louvers 110 that gives rise to a more desired spatial dispersion of light on reflection from a component of the louvers 110 as shown in the comparison of ray tracing of a flat louver in FIG. 4A to the innovative louvers 110 in FIG. 4B.

It should be understood that FIGS. 3A-C illustrate non limiting examples of how various surfaces shapes may be deployed within or on the louver 110 with the reflective layer 115 at various locations.

In FIG. 3A the reflective layer 115 is covered by a transparent sheet or film 111 having an upper and outer surface that forms the louver upper surface 110a. The reflective layer 115 may be a metal or dielectric reflector deposited on the lower surface 111b of transparent sheet or film 111 which can be bonded to a thicker substrate layer 117 that provides for relative rigidity of the louver 110. The lamination of the reflector coated film transparent sheet or film 111 can be with one or more adhesive layers 113. As light impinging on the surface 110a will be internally refracted at an angle that varies with the angle of incidence according to Snell’s law. The rays will then be transmitted through the transparent sheet or film 111 and then be reflected by the reflective layer 115 and redirected toward the upper right to the room or interior ceiling 12. Refraction again occurs as the reflected ray segments 11 exits at surface 111a. As the local variation in shape from the depth modulation various along the transverse or T axis there is a corresponding local variation of the angle of incidence, parallel rays will undergo a similar angular dispersion on reflection off the reflective plano surface 115 as if the reflected directly off surface 111a. The lamination of the reflector coated film transparent film 114 can be with one or more adhesive layers 113.

Alternatively, in FIG. 3A the upper surface 110a has the desired modulation in depth but the reflective layer 115 is buried below the transparent layer or substrate 111 that is generally plano or does not have a pattern of modulation in depth on the side with the reflective layer 115. The upper surface 110a, being modulating in depth and having a varying shape will cause a similar variation in incident angle of the light impinging on the reflective surface 115 due to the variation in refraction via Snell’s law.

In FIG. 3B the reflective layer 115 can be at the top of the louver 110 or forming the upper surface 110a.

In FIG. 3C, the upper surface 110a may be plano, that is not having a periodic modulation in depth, and the reflective surface 115 is deposited on an underlying substrate 111 on the bottom 111b. The bottom 111b has a periodic modulation in depth that is replicated in the reflective layer 115 that is either metallic or a dielectric mirror. The louver 110 need not be planar on both sides and may be slightly curved to provide stiffness.

In FIG. 3C, the reflective layer 115 is deposited on a transparent substrate 111 with a modulation in depth, d, and adhered to the optionally plano substrate 117 with the adhesive 116. The adhesive 116 conforms to the plano surface of the thicker substrate 117 and depth modulation of the reflective surface 115.

In the embodiments of FIGS. 3A-3C the, among other embodiment, the lower surface 110b may be coated with or formed with light absorbing coating, paint or layer 119 that is essentially black to provide either privacy when tilted to near vertical or to absorb incident light to prevent a second reflection from an upper louver 110, which would re-direct some portion of incident light rays downward, increasing glare to inhabitants.

In FIGS. 4A and 4B the optical ray tracing in a bundle of parallel rays 10 from the sun is reflected off either a planar upper or reflective surface (FIG. 4B) or reflective surface 115 with a preferred periodic modulation in depth (FIG. 4A). The reflected ray bundle 11, which includes dashed ray 11′ from the reflective region with an effective slope α on reaching the ceiling 12 is wider, as illustrated by considering the ray bundle width if it had undergone specular reflection off the ceiling 12 at the same distance from the ceiling 12 as Wb in FIG. 4B, and Wa in FIG. 4A. Wa is greater than Wb as the undulating nature of the surface 115 as some ray in the reflected bundle 11 are at a higher angle of incidence when impinging on the ceiling 12.

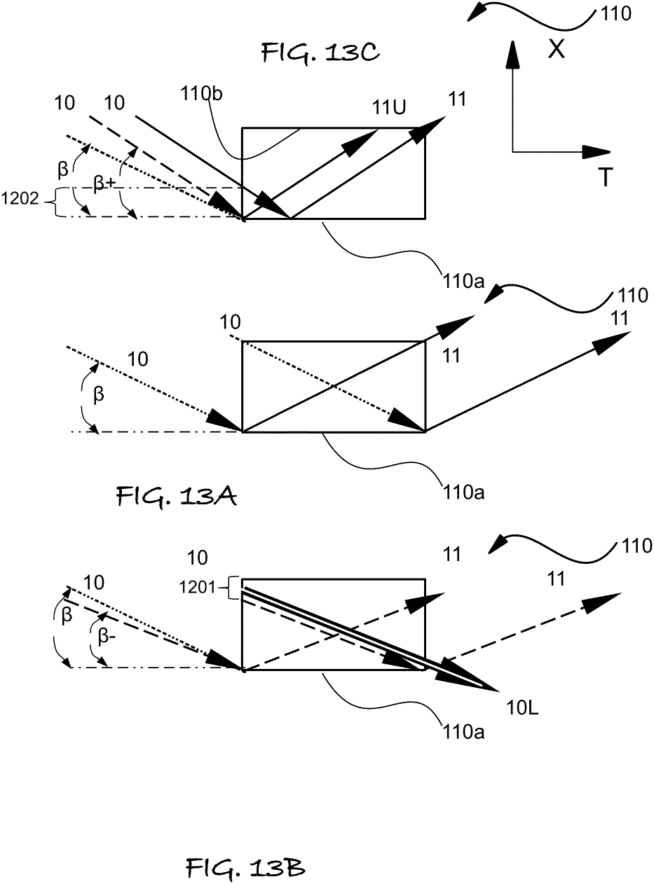

FIGS. 4A and B are ray tracings showing the difference between a plano louver on the left (FIG. 4A) which has no light spreading versus a louver 110 with the desired modulation in depth characterized by a maximum slope α of +/- 1 degree. The re-directed ray bundle from each louver now has a +/- 2 degree spreading angle (or 4 degrees total). A sinewave with a 2-degree max slope would have an 8-degree spreading angle. Likewise, a sinewave with a 3-degree max slope would have a 12-degree spreading angle. It is generally preferred to keep this spreading as low as possible because some incident light rays 10 will be vignetted by the adjacent upper louver 110, as illustrated in FIGS. 13A-C for different spacing of the louvers 110 at a given louver 110 width in the transverse axis.

As illustrated in FIG. 5, a more preferred shape of the effective reflective surface on the louver 110 is the arc of a portion of a circle 400 with radius R, alternating from the negative to the positive slope of the tangent portion over the limited circle arc. Hence, the continuous modulations in depth in this embodiment may be further characterized by vary periodically in circular arcs that oscillate between an upper arc portion of a circle and a lower arc portion of the circle in which a maximum tangent angle to the shape of the continuous modulations in depth occurs at junctions between the upper arc portions with the lower arc portion.

The maximum slope α on the different continuous modulations or waveforms may ranges between +/- 5 degrees. More preferably, the slope ranges between +/- 2 degrees, or less. Most preferably, the slope ranges between +/- 1 degree and greater than zero degrees. It is generally desired that the slope or tangent angle at the inflection point in the surface shape is varied to provide at least an increase in angular spread of reflected light off each louver 110 of at least about +/- 1 degree to eliminate the appearance of bright lines form each louver 111 appearing on the ceiling.

Moreover, the modulations in depth, d, preferably occur over a period or pitch P, which is on a micro-scale, usually less than 1 mm; more preferably less than 500 µm (500 microns or 0.5 mm); and most preferably below 100 µm. The selection of depth, d, and period or pitch P, determine the slope α. In a non-limiting example, a +/- 2-degree slope from a sine wave shaped waveform can be achieved with a depth, d = +/- 2 µm and a period or pitch P of 360 µm (0.36 mm)

The desired surface depth and shape variation in the transparent film or sheet 111 may be obtained by forming or casting the film or sheet 111 on a tool that is contoured by diamond turning to create a negative mold or master, or a positive master that is replicated to provide a negative mold. The diamond turning process is used to thread cut a cylinder for micro-replication, with a resulting film 111 that can subsequently be metalized by vacuum coating or plating to provide a reflective surface. In such a diamond turning process a piezo tool mount drives the diamond in and out of the cylinder during cutting by +/- 2 um and forms these wave-like depth modulations as described above. The cutting depth and setting of the start of each pass on the cylinder can forms the grooves in discrete bands 130.

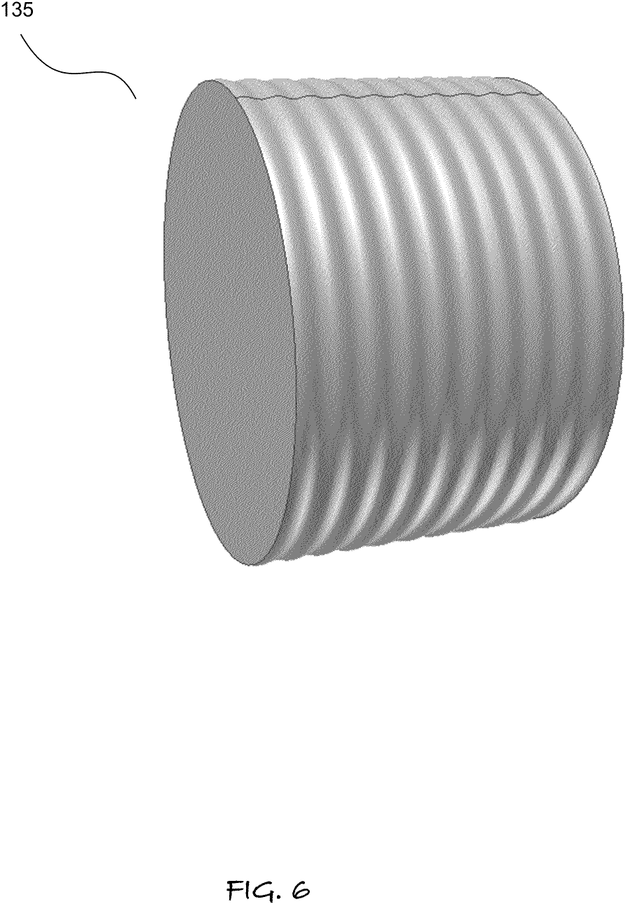

FIG. 6 illustrates in an exaggerated perspective view a continuous forming die or tool 135 that can be formed by diamond turning as a circular member to form the transparent sheet or film 111. Methods suitable for producing the tool 135 are disclosed in the following US Pat’s that are incorporated herein by reference: 9,180,524B2 (Campbell,A.B issued Nov. 10, 2015) and 10,683,979B2 (Gardiner, M.E. issued Jun. 16, 2020). The portion of the louver 110 which is the mirror image of the tool surface can be produced by replication with UV curable resins to form a solid surface. A liquid UV curable resin is coated on the rotating tool and solidified with actinic radiation, such as UV light. A solid film is stripped off the tool 135 or the tool 135 can be used to impress its surface shape on liquid UV curable resin that is supported by a web of transparent film, which on solidification forms the transparent film or sheet 111. The sheet 111 can form the top of the louver 110 when transparent with a reflective layer 115 deposited on the opposite side, or the reflective layer deposited directly on the side the shape of the tool 135 formed by diamond turning. The tool 135 would be formed by a step and repeat lateral movement of the cylinder in direction of the cylinder principal axis during turning process after each circular groove is formed in the tool 135. Alternatively, the cylinder can move continuously move laterally to form helical groove. The replicated film can be positioned or cut in forming hte louver so the grooves are orthogonal to the principal or long axis of the louver 110. A tool 135 can also be used to compression mold, stamp or coin press the surface shape into thermoplastic sheets or a more rigid material, such a metal, glass or ceramic covered by a thermoplastic sheet to form louvers 110 or components of louvers 110 formed by a lamination process. Thermoplastic sheets can be formed with sufficient additives to absorb UV radiation and stabilize the louver 110 better for exterior use in which UV radiation from the sun (or interior lighting fixtures) would not be absorbed by glazing.

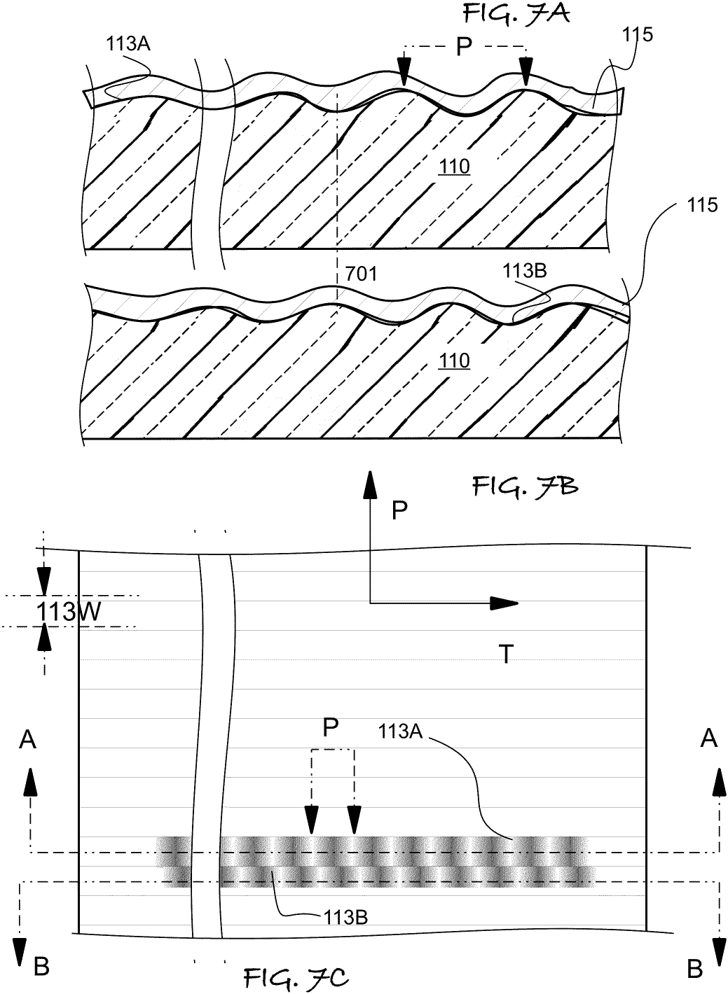

FIGS. 7A to 11B illustrate in various views for each embodiment a further improvement of the angular dispersion of reflected light rays 11 incident out of the plane of the paper, which is at an azimuthal angle δ, by also forming the reflective surface 115 in each louver 110 in discrete bands or grooves 113. The grooves or bands 113 are optionally formed in the transparent substrate 111 portion that supports the reflective layer 115 or as surface of the louver that is above the reflective layer 115. The adjacent and alternating bands 113A and 113B can be distinguished by modulating the absolute phase of the depth variation in adjacent bands, as shown in FIGS. 7A-7C by vertical reference line 701 to indicate the band 130 in FIG. 7A (section line A-A in FIG. 7C) is at the maximum depth, D, when the adjacent band 130 in FIG. 7B (section line B-B in FIG. 7C) is at the minimum depth, in which the upper height in each bands is offset from adjacent bands by some fraction of the pitch, P, such as half the pitch as illustrated.

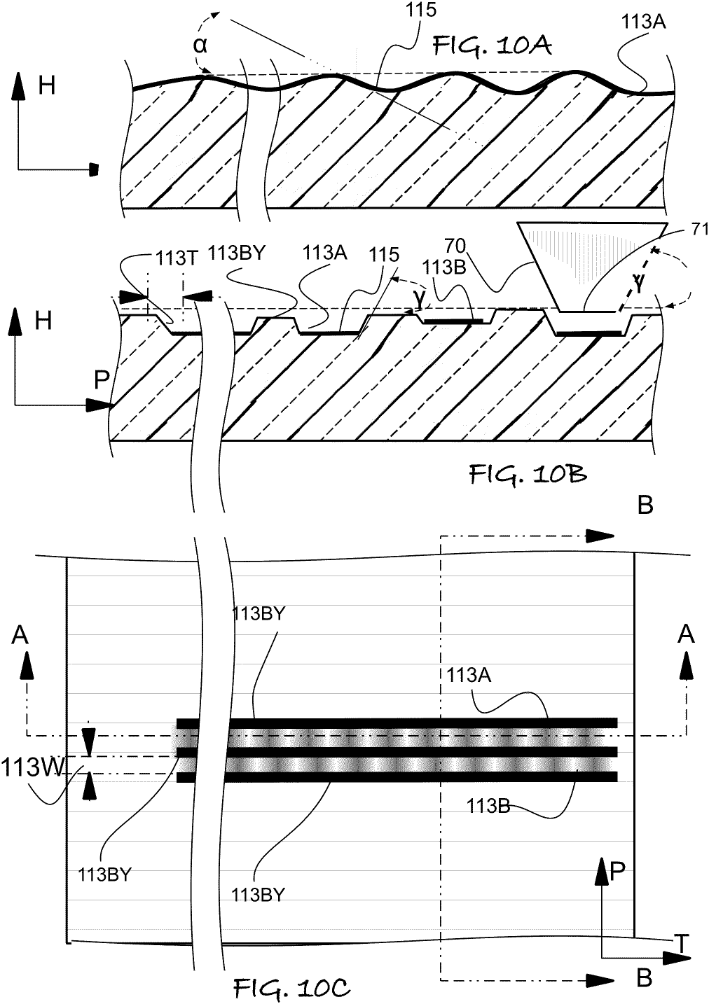

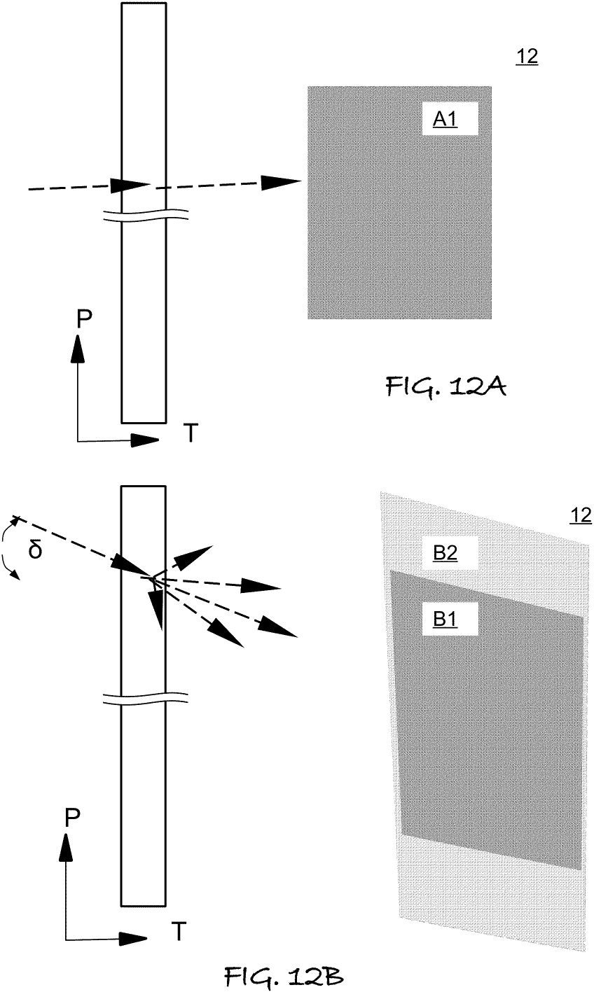

A flat surface within across each band 130 in the X-axis direction can be obtained with a flat diamond 70 (FIG. 10B) with a tip 71 with a width of approximately 50 µm and sloped sides with angle γ, thus the band width is preferably about 25 to 75 µm. A square tipped tool will eliminate the non-effective region between bands 113, but the bands if desired must be out of phase to provide lateral dispersion as illustrated in FIG. 12B.

Providing modulation in depth of the effective reflective surface 115 in discrete adjacent bands 113 results in additional improvement when the light impinges at a non-zero azimuthal angle as the sun orientation change along with elevation during the day. In FIG. 12A a single louver 110 of the optical panel 101 is shown in a plan view. To the right, a potential light intensity pattern across the interior ceiling 12 is illustrated in reverse contrast, which is brighter regions are darker, while the darker regions in the Figures would be the regions of greatest re-directed light intensity. In area outside the rectangles receive no re-directed sunlight.

As illustrated schematically in FIG. 12B, the pitch, pitch offset and/or height difference between adjacent bands 130 cause angular dispersion by diffraction with multiple order that deviate positively and negatively from the Fresnel reflection of incident light. These diffractions cause the distortion of the smaller square region on the ceiling 12 in FIG. 12A into parallelogram in the right side of FIG. 12B. However, the diffraction at the groove or band 113 boundaries results in the lateral dispersion of light beyond the smaller and darker parallelogram (B1), which is broadened in the upward and downward directions (B2) so that re-directed sunlight is still illuminating the upper region of the room, despite the relative movement of the sun. For an occupant facing the window deploying the panel 101, the light on the ceiling 12 would be spread farther to the left and right than in embodiments without the grooves or bands 113.

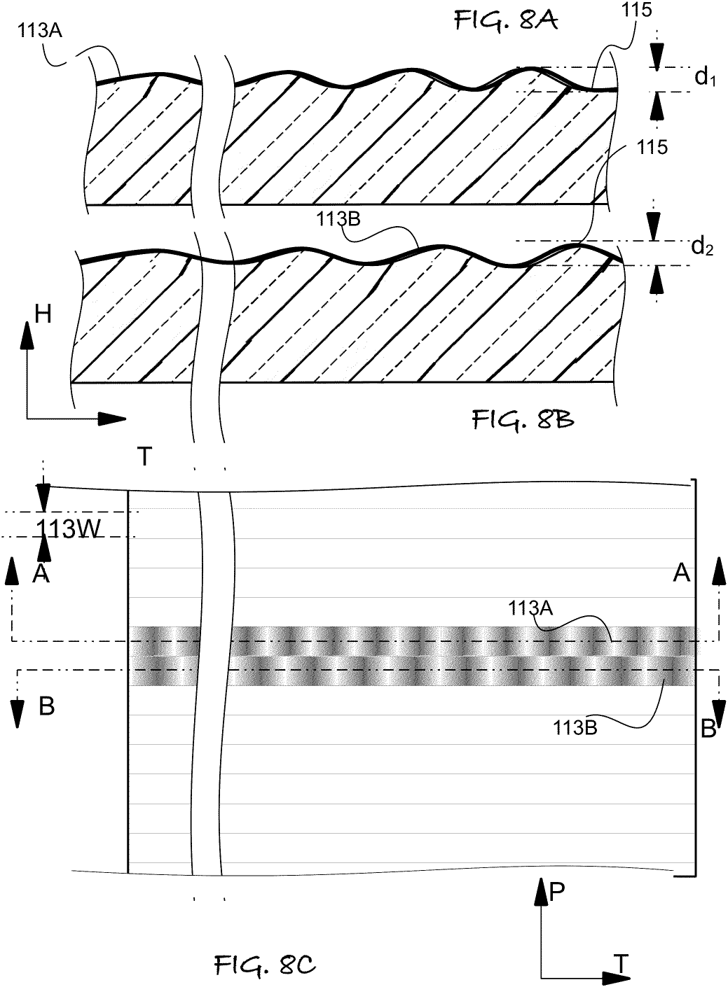

In FIGS. 8A-C, the bands 113 have a width shown by ref. no. 113W. FIG. 8A shows the surface 110a or reflective layer 115 shape at the band 113A at section line A-A in FIG. 8A, whereas the adjacent bands 113B has the same shape in FIG. 8B, being offset or out of phase in the T axis direction by the differences in pitch within adjacent bands, as shown by modulations in darkness to represent depth, in FIG. 8C, at section line B-B thereof. Depending on the spacing and number of windows in a room or work area, the lateral dispersion to provide light pattern B2 in FIG. 1 can be adjusted to minimize lighting gaps taking into account the scattering of light off a light ceiling 12 by varying width of the bands 113A and 113B. It should be understood that bands 113A and 113B may alternate across a part of the entire surface of the louver 110, and does not preclude the louver having other bands that alternative in regular or random patterns that differ in depth, pitch, offset, width or spacing, as described in the following non-limiting examples with respect to FIGS. 8A-10C. Such variation of the neighboring or adjacent bands may occur on all louvers 110 of the device 1000, or some of the louvers 110, or vary from louver to louver.

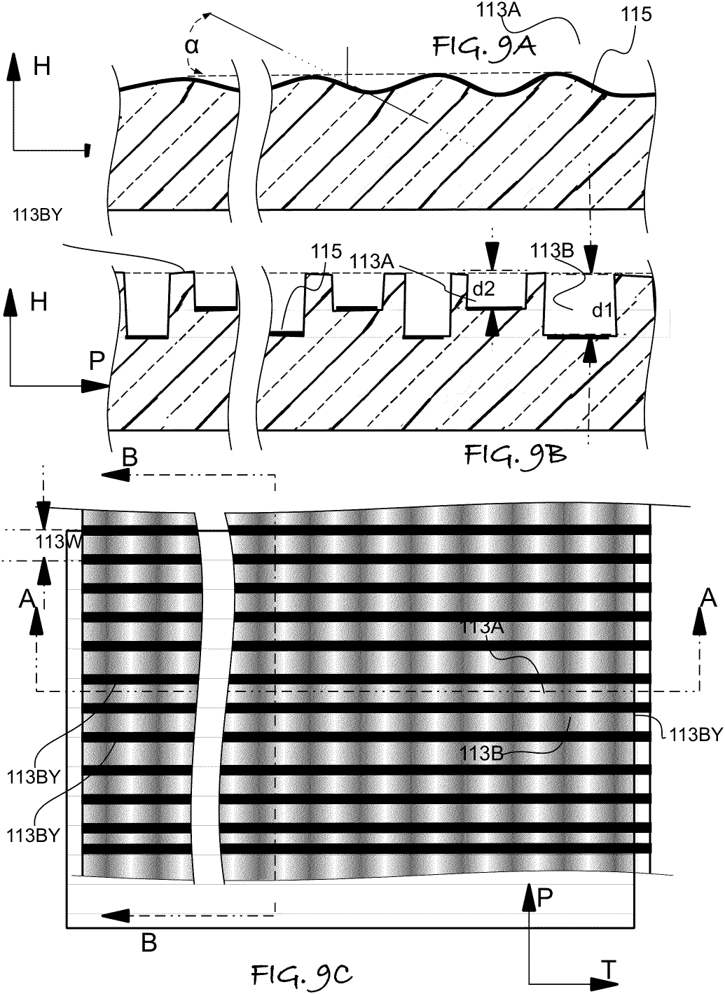

In FIGS. 9A-C the bands 113A and 113B with width 113W have a different depth but the same general shape and are out of phase in the direction of the T axis. The band 113A at section line A-A corresponds with FIG. 9A with a depth d₁, and the band 113B at section line B-B corresponds with FIG. 9B with a depth d₂ in which d₁ is larger than d₂. Adjacent bands 113A and 113B can be the same or varying width across a louver 110, and can be out of phase with the same pitch or vary in pitch.

In FIGS. 10A-C the bands 113A and 113B have the same depth shape but are out phase in the direction of the T axis with the same pitch P, but are also each offset in absolute depth above or below the maximum height of the adjacent band. In addition, the boundary 113T between bands 113A and 113B is not vertical but tilted at angle γ or the space or boundary 113B that is not recessed. The angle γ may correspond with the draft angle of the diamond 70, which is preferably a small draft angle γ like 1 to 20 degrees. More preferably 1 to 10 degrees and even more preferably 1 to 5 degrees, in which the diamond 70 produces an almost a square wave form (FIG. 9B). Thus, the draft angle γ of the diamond tool 70 may be replicated at the transition zone or part of boundary 113BY between adjacent grooves or bands 130, such as a cylindrical from, like the tool 135 in FIG. 6.

It should be appreciated from the following examples in FIGS. 12A-12C that louvers 110 have limitations in the efficiency of light redirection that is very dependent on the louver 110 aspect ratio and the incident angle of the solar radiation, β. By efficiency we mean the fraction of the incident light that can re-directed upward on reflection from the louvers and will impinge on the room ceiling 12.

Optimum performance of louvers 110 in optical panel 101 is best understood in relation to the aspect ratio set by the louver width in the transverse or T axis and the spacing in the X or vertical axis when the solar radiation is incident and parallel to the plane of the X and Transverse axis, which is when the azimuthal incident angle δ is zero.

In FIG. 13A all the incident sunlight impinges on the louver 110 at the upper surface 110a and on reflection reaches the ceiling 12, for 100% efficiency. This condition and the optimum sunlight angle of incidence is for 100% efficiency is simply a function of the aspect ratio of the vertical spacing of the gaps 10 to the louver width. The angle β for 100% efficiency is the arctangent (vertical spacing/transverse width).

For angles of incident sunlight less than β (β-) in FIG. 13B, a portion of the incident light leaks through the louvers 110 as ray 10L without reflection, with the bracket 1201 showing the vertical extent of light rays that will leak.

For angles of incident sunlight greater than β (β+) in FIG. 13C, a portion of the incident light though reflecting off the louvers upper surface 110a or other reflective surface, then impinges on the back surface of the upper louver as ray 11U, where it is lost by absorption, scatter or some reflection downward toward the floor, rather than upward at an interior ceiling 12. All downward reflected light will cause bothersome glare to occupants. Bracket 1202 shows the vertical extent of incident light rays 10 that will be reflected as rays 11U and impinge on the bottom surface 110b of the upper louver that will leak.

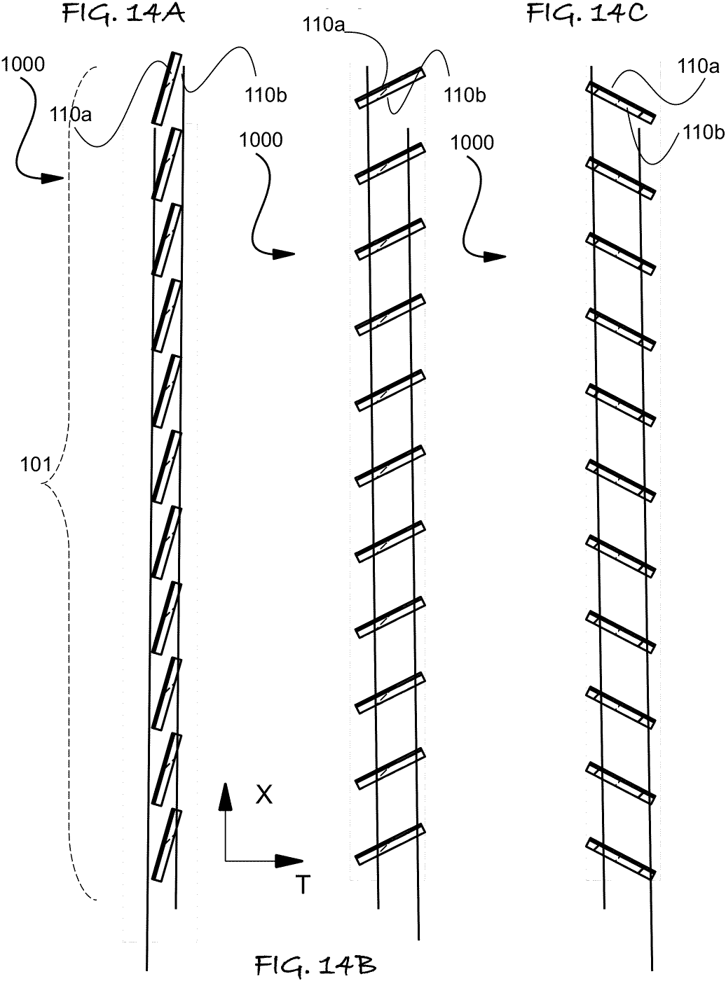

The louvers 110 can be tilted collectively to more efficiently utilize the light rays 10 incident on the panel 101 having louver 110 in FIGS. 13B and 12C, by either clockwise or counterclockwise rotation, as shown respectively in FIGS. 14C and 14B. FIG. 14A, shows a nearly complete counterclockwise rotation to position the upper surface 110a facing leftward toward the window and the sun. This arrangement provides privacy as well as generally blocks low angle sun when it would cause bothersome glare.

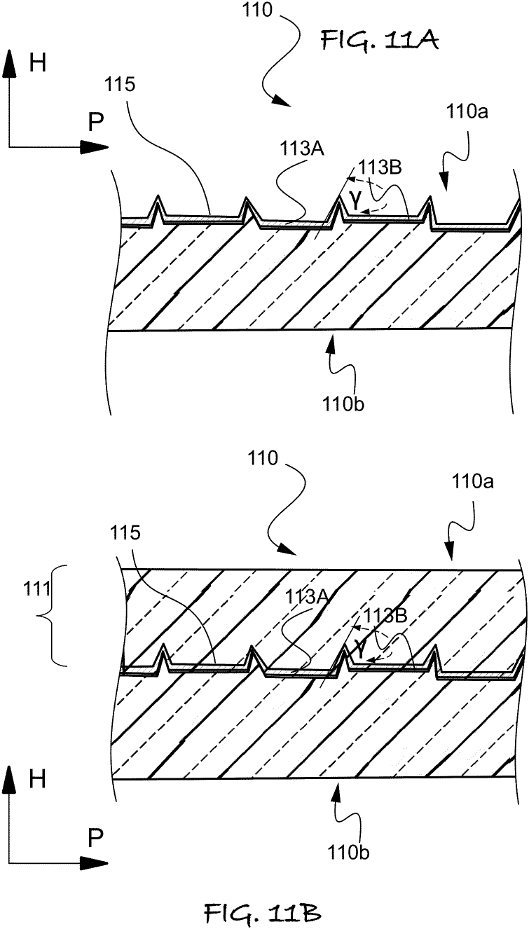

In preferred embodiments the boundary 113T between bands is minimized by overlapping cuts of the diamond tool, flat regions would produce specular reflection defeating the purpose of spreading the incident sunlight more broadly on the room ceiling 12 to avoid projecting bright images of spaced apart louvers. FIGS. 11A and 11B illustrate variations on such an embodiment now showing reflective layer 115, which is on the top 110a of the louver 110 in FIG. 11A, but underneath a transparent protective layer in FIG. 11B. The gap between adjacent bands 113A and 113B, which alternate across the louver 110, is essentially a point when the replication tool fabrication is optimized so the successive passes to remove material from a master in turning slightly overlap, and the slow of the sides of the bands up to this point is the draft angle of the cutting tool, which depending on the depth of the bands may be further minimized to be a negligible fraction of the band width 113W.

The width 113W of the bands 113 is preferably between about 10 µm to about 1000 µm, If it is desirable to provide more side to side diffraction as illustrated in FIG. 12B. The depth of the wave like or semi-circular depth modulations in bands 113, or across the entire louver 110 is are preferably about 150 µm or less, more preferably about 50 µm or least and most preferably about 25 µm.

The phase difference between the waveform in adjacent bands 113, if desired to product lateral dispersion is preferably at least about ¼ of the wavelength of peak to peak spacing in the direct of each band 113.

If desirable to minimize side to side diffraction, the band width 113W is preferable about 1000 µm, or greater. If it is desirable to maximize the side-to-side diffraction, the band width 113W is preferably about 10 µm area, or even smaller. There is another consideration potential consideration when it comes diamond turning to produce a master for molding the louvers 110. A larger tool tip may increase the force on the work piece, in which the corresponding reaction is tool chatter, which may provide a preference to minimize the band width 113W to the 10 to 100 µm range .

The reflective layer 115 in the various embodiment described is also optionally a dielectric cold mirror to reflect visible light, but transmit infrared light, which is also disclosed in the applicant’s pending application, which published as US Pat. Application US20220252234A1 on Sep. 11, 2022 with the title “Devices for Internal Daylighting with IR rejection”, and is incorporated herein by reference.

The preferred wave form of the effective reflective surface, be it the reflective layer 115, or an undulating transparent top layer that cause a refractive deviation of the incident light from both transmission from air into the top layer, and second refractive deviation on exit after reflecting of a planar layer may vary with the desired maximum tangent angle, which is preferably below about 4 degrees, more preferably below about 2 degrees and most preferably about 1 degree.

If the depth from the peak to the valley of the waveform is between about 10 to 30 µm, then the mean surface wavelengths or pitch, P, will range from 0.5 mm to 3.5 mm depending upon max slope. It may be desirable to keep the wavelengths near 1 mm, with a correspondingly lower depth or peak to valley distance over the waveform.

FIGS. 14A and 14B illustrate the daylighting device 1000 disposed between glazing panel of a window assembly in which the louvers 110 in FIG. 14A may be fixed into a rigid panel that is inserted between the glazing panels. In contrast, FIG. 14B illustrates the louvers 110 of the daylighting device 1000 can be collectively tilted from the fixed orientation in FIG. 14A.

The daylighting device 1000 in which the louvers 110 are fixed or capable of being rotated may be deployed external to a building as disclosed in commonly owned U.S. Pat. No. 11248763B2, for “High efficiency external daylighting device” by Gardiner; Mark E. which issued on Feb. 15, 2022, and is incorporated herein by reference. The optical panel 1000 may have air gaps between louvers 110, or a transparent spacer that precludes louver tilting, but would form a rigid panel 1000.

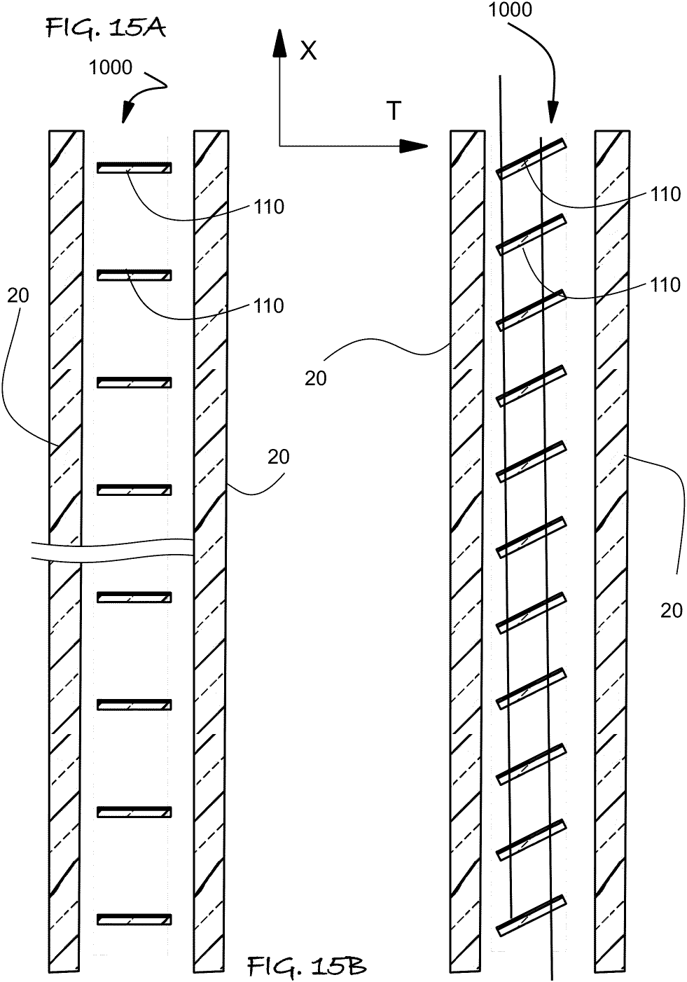

The optical panel 1000 formed from a plurality of stacked louvers may be deployed between layers of window glazing 20, as illustrated in FIG. 15A in which the louvers remain fixed and orthogonal to plane or face of the glazing 20, whereas in FIG. 15B, the louvers 110 can collectively tilt as disclosed in other embodiments. The optical panel 1000 may have air gaps between louvers 110, or a transparent spacer that precludes louver tilting, but would form a rigid panel 1000.

However, while the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. An optical panel that comprises a plurality spaced apart elongated reflective elements arranged in a stack that spans a height of the optical panel and each reflective element in said plurality has a first surface and an opposing second surface in which,
a. at least one reflective layer is one of disposed on the first surface, the second surface and between the first and second surface,
b. the at least one of the upper surface and the reflective layer being further characterized by a continuous modulation in depth in a direction orthogonal to a principal axis of the elongated reflective elements.

2. The optical panel of claim 1 in which the continuous modulation in depth is further characterized by vary periodically in circular arcs that oscillate between an upper arc portion of a circle and a lower arc portion of the circle in which a maximum tangent angle to the shape of the continuous modulations in depth occurs at junctions between the upper arc portions with the lower arc portion.

3. The optical panel of claim 2 in which the continuous modulations in depth provide maximum tangent angle to the resulting surface that is less than about 5 degrees.

4. The optical panel of claim 1 in which the continuous modulation in depth is further characterized by a maximum tangent angle to the resulting surface that is less than about 5 degrees.

5. The optical panel of claim 1 in which the continuous modulations occur within a plurality of adjacent bands spaced apart along the principal axis of the elongated reflective elements in which each band extends in a direction orthogonal to the principal axis of the elongated reflective elements.

6. The optical panel of claim 2 in which the continuous modulations occur within a plurality of adj acent bands spaced apart along the principal axis of the elongated reflective elements in which each band extends in a direction orthogonal to the principal axis of the elongated reflective elements.

7. The optical panel of claim 6 in which at least some of bands in the plurality vary in one of depth and phase from at least one of the nearest neighboring bands.

8. The optical panel of claim 5 in which spaced apart elongated reflective elements are substantially planar relative to an upper most surface between the bands.

9. The optical panel of claim 1 in which the least one reflective layer is disposed between the first and second surface and the elongated reflective elements have a transparent layer between the upper surface and the at least one reflective layer.

10. The optical panel of claim 9 in which the continuous modulations in depth are on the upper surface.

11. The optical panel of claim 9 in which the continuous modulations in depth are on the at least one reflective layer.

12. The optical panel of claim 11 in which the continuous modulations in depth are on the at least one reflective layer in which the upper surface is planar.

13. The optical panel of claim 1 in which the continuous modulations occur within a plurality of adj acent bands spaced apart along the principal axis of the elongated reflective elements in which each band extends in a direction orthogonal to the principal axis of the elongated elements to provide for diffraction of light incident at non-zero azimuthal angles.

14. The optical panel of claim 1 at least some of the bands of the said plurality have a width from about 10 µm to about 1000 µm.

15. The optical panel of claim 3 in which the continuous modulations in depth have the maximum tangent angle that is less than about 3 degrees and at least about 1 degree.

16. The optical panel of claim 4 in which the continuous modulation in depth is further characterized by a maximum tangent angle to the shape of the continuous modulations in depth that is at least about 1 degree.

17. The optical panel of claim 1in which the continuous modulations in depth have a pitch that is between about 0.5 mm to about 3.5 mm.

18. The optical panel of claim 1 in which the continuous modulations in depth from the peak to the valleys of the waveforms is about 10 to about 30 µm.

19. The optical panel of claim 17 in which the continuous modulations in depth from the peak to the valleys of the waveforms is about 10 to about 30 µm.

20. The optical panel of claim 1 in which at least some of the spaced apart elongated reflective elements are separated by one of an air gap and a rigid transparent spacer.

21. A window comprising a front glazing sheet and a spaced apart rear glazing sheet, with an optical panel disposed between the front and rear glazing sheet in which the optical panel optical panel that comprises a plurality spaced apart elongated reflective elements arranged in a stack that spans a height of the optical panel and each reflective element in said plurality has a first surface and an opposing second surface in which,
a. at least one reflective layer is one of disposed on the first surface, the second surface and between the first and second surface,
b. the at least one of the upper surface and the reflective layer being further characterized by a continuous modulation in depth in a direction orthogonal to a principal axis of the elongated reflective elements.
